(19) United States
(12) Patent Application Publication
(10) Pub. No.: US 2018/0120073 A1
(43) Pub. Date: May 3, 2018

(54) DETONATOR CONTROL SYSTEM

(71) Applicant: DETNET SOUTH AFRICA (PTY) LTD, Woodmead (ZA)

(72) Inventors: Abraham Johannes Liebenberg, Kempton Park (ZA); Michiel Jacobus Kruger, Rembrandt Park (ZA); Aldaine Whyte, Pretoria East (ZA)

(21) Appl. No.: 15/573,376

(22) PCT Filed: May 4, 2016
(86) PCT No.: PCT/ZA2016/050015

§ 371 Date: Nov. 10, 2017

(30) Foreign Application Priority Data
May 12, 2015 (ZA) 2015/03270

(51) Int. Cl. F42D 1/045; F42D 3/06; F42D 1/04

(52) U.S. Cl. CPC F42D 1/045; G01S 19/14; F42D 1/043; F42D 3/06

(57) ABSTRACT

A method of locating a borehole and a detonator in a blasting system which includes a number of boreholes and detonators, wherein an operator uses a mobile device which presents to the operator identity and location information of a borehole but only if the borehole is within a predetermined distance of the operator.

### BACKGROUND OF THE INVENTION

This invention relates generally to the use of one or more detonators in a geophysical exploration process to generate seismic information and more particularly is concerned with the provision of information, to an operator or to a control system, which facilitates the implementation of a seismic blasting system.

In a geophysical exploration process use can be made of one or more electronic detonators to create an explosion which generates seismic waves. Reflections of the seismic waves by geophysical formations and discontinuities in the earth are measured and are processed to obtain an indication of properties below the earth's surface.

In a seismic application boreholes are normally primed well in advance before firing the respective detonators in the boreholes. It is not uncommon for a period of up to two or three months to pass, once a detonator is loaded into a borehole, before the detonator is fired.

It is therefore essential to have continuity of information for an unattended primed borehole with a seismic blasting detonator may otherwise be inadvertently initiated.

Generally adequate techniques are available in the prior art to prevent a detonator from being prematurely initiated by an extraneous signal. For example a detonator may be responsive only to a specific encoded firing signal. However a substantial degree of time and effort is required to “re-establish” a seismic system in a safe and effective manner after a dormant period of several weeks (say). Each borehole must be found and identified. Information pertaining to each detonator in the borehole must be validated and, only then. can controlled firing of each detonator take place to generate the required seismic information.

Typically, when the time comes for firing the detonators, an operator using a hand-held blaster traverses a blast site and locates the individual boreholes. A connection is made to the respective detonator and, subsequently, after validation processes, blasting takes place. As a seismic site can be extensive in area and, given that a fairly long period may have passed from the time a blast site was established to the time at which blasting is to take place, care must be taken to ensure that the detonators are correctly identified and are correctly fired.

An object of the present invention is to provide a blasting system which lends itself to use particularly in a seismic arrangement, in which this aspect is, at least to some extent, facilitated.

### SUMMARY OF THE INVENTION

The invention provides a blasting system which includes a plurality of boreholes, wherein each borehole is respectively loaded with at least one detonator and with an explosive material, and at least one mobile device, under the control of an operator, which presents information to the operator on the location and identity of at least one of the boreholes, only if the borehole is within a predetermined distance of the operator.

Depending on the extent of the predetermined distance the mobile device may present information on the location and identity of each borehole which is within said predetermined distance.

The mobile device may include a tagger or a hand held blaster, a communication unit, a processor and an output device which provides visual or audible information or both, to an operator. The invention is not limited in this respect.

For example, within a given radius from the position of the operator, which position is coincident with the location of the mobile device, the system may present information on each detonator or borehole within that radius. The information may relate to any of the following: positional information, identity information i.e. the identity of a borehole and the identity of a detonator, and directional information e.g. route information of a path to be travelled by an operator to reach a particular detonator or borehole. The invention is not limited in respect of the nature of the information.

The size of the radius, which determines the extent of the area on which information is presented to the operator, may be adjustable.

The information may be held in the mobile device or it may be transferred to the mobile device, as appropriate, from a database at a central controller. The system may include a controller which on an ongoing basis verifies the location of the mobile device (i.e. the position of the operator) relative to positional information previously collected and stored e.g. in the mobile device or in a database at a central location. If an information match is not recorded then the system may automatically take appropriate action e.g. it may generate a warning message to the operator, or the system can log the event to allow remedial action to be taken.

The invention also extends to a method of controlling operation of a blasting system which includes a plurality of boreholes, wherein each borehole is respectively loaded with at least one detonator and with an explosive material, wherein the method includes the steps of recording the identity and location of each borehole or detonator in the system and of subsequently using a mobile device which presents information on such identity or location to an operator of the device but only in respect of each borehole or detonator which is in the blasting system and which is within a predetermined distance of the operator.

There are two important aspects to the invention. The mobile device may collect information from each detonator within the predetermined area and compare this to previously collected and stored information using geographical data in order to correlate the collected information with the stored information. Secondly, again using geographical (positional) data as a control parameter, the relevant stored information is made available to an operator who can then verify that this information is accurate by using the mobile device as appropriate.

### BRIEF DESCRIPTION OF THE DRAWINGS

The invention is further described by way of example with reference to the accompanying drawings in which:

FIG. 1 illustrates, somewhat schematically, a detonator system according to the invention, and

FIGS. 2 and 3 illustrate aspects of the working of the system.

### DESCRIPTION OF PREFERRED EMBODIMENT

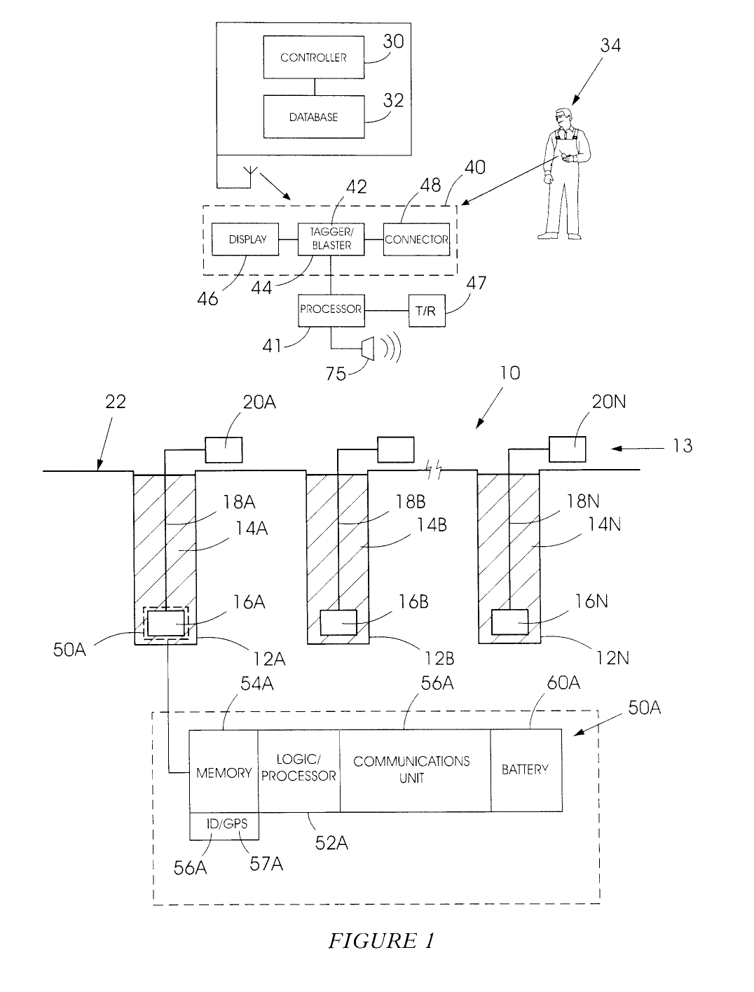

FIG. 1 of the accompanying drawings schematically illustrates a blasting system 10 which includes a number of boreholes 12A, 12B . . . 12N at a blast site 13 and which is used to establish a seismic arrangement. Each borehole is drilled to a predetermined depth and is loaded with a respective explosive material 14A, 14B . . . 14N and with one or more detonators 16A, 16B 16N. Each detonator 16A . . . 16N is connected via a respective wire or conductor 18A . . . 18N to a respective connector 20A . . . 20N located on a surface 22. The connectors (20A-20N) may be coupled via the respective conductors (18A-18N) to a surface harness or a bus (not shown) or use can be made of wireless connection techniques to establish communication between each detonator (16A-16N) and a central controller 30.

In order to control aspects of the operation of the blasting system use is made of the central controller 30 which is connected to a database 32. An operator 34, who traverses the blast site 13, carries at least one mobile device 40 which includes a processor 41, a tagger 42, a handheld blaster 44, and a display 46. The device 40 also includes a transmitter/receiver unit 47 which communicates, wirelessly, with the central controller 30. The device 40 has output terminals in the form of a connector 48 which can be coupled directly to any of the connectors 20 on the surface 22. Alternatively a wireless link can be established under controlled conditions between the mobile device 40 and any selected connector 20 (or detonator 16).

In a seismic exploration arrangement the boreholes 12 are drilled in a predetermined pattern over a surface which is to be seismically mapped. Positional data, determined for example from a GPS system (not shown), relating to the position of each borehole. is stored in the database 32. Subsequently each borehole 12 is loaded with its respective explosive material 14 and detonator 16. At this time, or shortly thereafter, data (as may be required for seismic purposes) on each borehole installation is collected via the tagger 42.

An insert drawing in FIG. 1 illustrates an electronic module 50A associated with a respective detonator 16A. Other components of the detonator 16A are not illustrated. The module 50A includes a logic/processor unit 52A, a memory unit 54A in which is stored, inter alia, an identity number (56A) for the detonator and information (57A) relating to the position of the detonator, a communication unit 58A, and a battery 60A for powering electronic components of the detonator. The module 50A could form a part of the detonator 16A, or of the respective connector 20A.

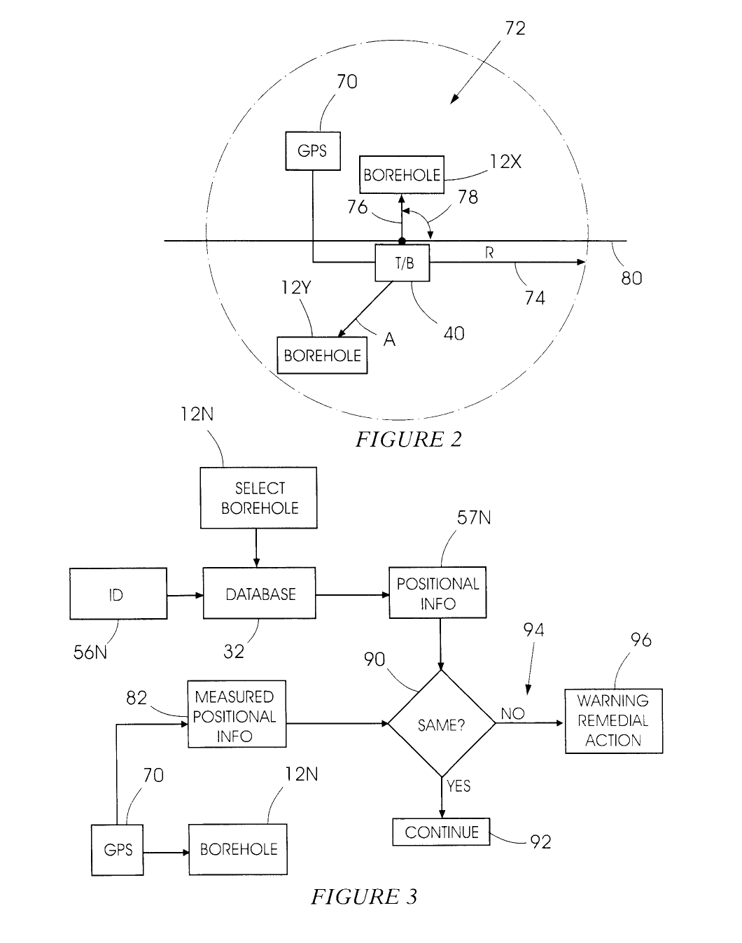

FIG. 2 illustrates the mobile device 40, which contains one or both of the tagger 42 and the hand held blaster 44, and which is carried by the operator 34 as the operator traverses the blast site 13. The mobile device 40 includes or is linked to a GPS module 70 which continuously and automatically provides positional information to the operator 34. The operator 34 uses the processor 41 to set the extent of an area 72 by defining a radius 74 which extends from the position of the mobile device 40 and which encloses the area 72. The setting of the radius 74 depends on a variety of factors including the density of the boreholes 12 at the blast site 13 and on the nature of the terrain on which the blast site is located.

As the operator 34 moves the geographical position of the area 72, in an absolute sense, also moves. If boreholes 12X and 12Y fall inside the area 72 then. at that time. the respective identifiers 56X and 56Y of the boreholes 12X and 12Y are presented to the operator 34 on the display 46. This is achieved by using the unit 47 to communicate with the central controller 30 so that positional information, previously stored in the database and pertaining to each of the detonators 16 at the blast site can be presented on a continuous basis to the operator.

The operator is then free to approach the borehole 12X, or the borehole 12Y as he chooses. The operator can then carry out further operations pertaining to the establishment of the seismic arrangement.

Information relating to or arising from detonators and boreholes outside of the area 72 is rejected or not processed and so is not presented to the operator 34 for processing.

Directional information may be given to the operator 34 to assist the operator to the site of a chosen borehole. The directional information may be given by spoken commands produced by the processor 41 acting on a loudspeaker 75 using information generated by the GPS module 70, or the directional information may be visually conveyed to the operator 34 on the display 46 by indicating a direction 76 to a chosen borehole 12X with the direction being specified at least with reference to an angular deviation 78 from a reference plane or line 80. These aspects are exemplary only and non-limiting.

A flow chart in FIG. 3 illustrates some operational steps. A borehole 12N (as is the case with all of the other boreholes in the blasting system 10), is initially identified by means of a unique number given to the borehole 12N or by means of an identifier 56A which is given to a detonator 16N placed in the borehole 12N at the time the blasting system 10 is initially established. This identification information is held in the database 32.

The GPS module 70, which is linked to the mobile device 40 carried by the operator 34, generates positional information 82 pertaining to the location, at the time. of the GPS module 70.

The operator 34 selects the borehole 12N by specifying the identity number 57N of the borehole 12N or the identifier 56N of the detonator 16N which is held in the borehole 12N. The positional information 57N which is held in the database 32 and the corresponding detonator identity number 56N are then presented to the operator 34 on the display 46 of the mobile device 40. This borehole positional information 57N is compared to the positional information 82 (of the borehole 12N) which is being measured at the time by the GPS 70 which is linked to the mobile device 40. If the outcome of a comparative process 90 is positive then the setting up of the seismic arrangement can continue (step 92). If the outcome of the comparative process is negative (step 94) then the operator 34 is warned of the discrepancy e.g. the operator is possibly not at the correct borehole or some other error has occurred. The event is logged as may be required and, if necessary, appropriate remedial action is taken (step 96).

The control sequence substantially enhances the operation of a seismic exploration process in that the detonators (12A . . . 12N) must be correctly identified before firing takes place. Additionally, the locating of the individual detonators 16 and boreholes 12 by an operator 34 is facilitated.

1-13. (canceled)

14. A blasting system which includes a plurality of boreholes at a blast site wherein each borehole is respectively loaded with at least one detonator and with an explosive material, and at least one mobile device under the control of an operator, which presents information to the operator on the location and identity of each detonator or borehole only if the borehole is within a predetermined radius from the position of the operator and wherein the position is coincident with the location of the mobile device and wherein the size of the radius is adjustable in dependence on the density of the boreholes at the blast site and on the nature of the terrain at the blast site.

15. A blasting system according to claim 14, wherein the mobile device presents information on the location and identity of all boreholes, or of all the respective detonators in all of the boreholes, which are within the predetermined radius.

16. A blasting system according to claim 15, wherein the mobile device includes a processor, a tagger or a blaster, a communication unit, and an audible or visual output device.

17. A blasting system according to claim 16, wherein the presented information relates to any of the following:
1. positional information of the borehole or detonator;
2. the identity of the borehole;
3. the identity of the detonator;
4. general soil information and/or
5. warnings related to the borehole.

18. A blasting system according to claim 17, wherein directional information is given to the operator to enable the operator to reach a particular detonator or borehole.

19. A blasting system according to claim 18, wherein the information is held in the mobile device, or it is transferred to the mobile device, from a database at a central controller.

20. A blasting system according to claim 19, further comprises a central controller which, on an ongoing basis, verifies or determines the location of the mobile device relative to positional information, relating to the boreholes or to the detonators, previously collected and stored in the mobile device or in a database at the central controller.

21. A blasting system according to claim 20, wherein a warning message to the operator is generated if there is a discrepancy in respect of the position of the mobile device relative to any borehole within said predetermined radius and the position of the borehole relative to the previously collected and stored positional information.

22. A blasting system according to claim 15, wherein the presented information relates to any of the following:
1. positional information of the borehole or detonator;
2. the identity of the borehole;
3. the identity of the detonator;
4. general soil information and/or
5. warnings related to the borehole.

23. A blasting system according to claim 22, wherein directional information is given to the operator to enable the operator to reach a particular detonator or borehole.

24. A blasting system according to claim 22, wherein the information is held in the mobile device, or it is transferred to the mobile device, from a database at a central controller.

25. A blasting system according to claim 22, further comprises a central controller which, on an ongoing basis, verifies or determines the location of the mobile device relative to positional information, relating to the boreholes or to the detonators, previously collected and stored in the mobile device or in a database at the central controller.

26. A blasting system according to claim 22, wherein a warning message to the operator is generated if there is a discrepancy in respect of the position of the mobile device relative to any borehole within said predetermined radius and the position of the borehole relative to the previously collected and stored positional information.

27. A blasting system according to claim 14, wherein the presented information relates to any of the following:
1. positional information of the borehole or detonator;
2. the identity of the borehole;
3. the identity of the detonator;
4. general soil information and/or
5. warnings related to the borehole.

28. A blasting system according to claim 14, wherein directional information is given to the operator to enable the operator to reach a particular detonator or borehole.

29. A blasting system according to claim 14, wherein the information is held in the mobile device, or it is transferred to the mobile device, from a database at a central controller.

30. A blasting system according to claim 14, further comprises a central controller which, on an ongoing basis, verifies or determines the location of the mobile device relative to positional information, relating to the boreholes or to the detonators, previously collected and stored in the mobile device or in a database at the central controller.

31. A blasting system according to claim 14, wherein a warning message to the operator is generated if there is a discrepancy in respect of the position of the mobile device relative to any borehole within said predetermined radius and the position of the borehole relative to the previously collected and stored positional information.
